(19) United States
(12) Patent Application Publication
(10) Pub. No.: US 2026/0197035 A1
(43) Pub. Date: Jul. 9, 2026

(54) ACCESS NETWORK COMPRISING RECONFIGURABLE REFLECTIVE SURFACES, METHOD AND DEVICE FOR CONTROLLING SUCH AN ACCESS NETWORK

(71) Applicant: Orange, Issy-Les-Moulineaux (FR)

(72) Inventors: Youssef HUSSEIN, Chatillon Cedex (FR); Thierry CLESSIENNE, Chatillon Cedex (FR)

(21) Appl. No.: 19/134,432

(22) PCT Filed: Nov. 30, 2023
(86) PCT No.: PCT/EP2023/083712

§ 371 Date: Dec. 30, 2025

(30) Foreign Application Priority Data
Dec. 2, 2022 (FR) FR2212709

(51) Int. Cl. H04B 7/04

(52) U.S. Cl. CPC H04B 7/04013

(57) ABSTRACT

An access network including a base station for exchanging data with user terminals located in a geographical region to be served, the base station including an antenna array, the access network further including a plurality of reconfigurable intelligent surfaces adapted to reflect incident radio signals, each reconfigurable intelligent surface being a surface including a plurality of elements for which their respective reflective properties can be modified by a control module for the reconfigurable intelligent surface. The plurality of reconfigurable intelligent surfaces includes: a main reconfigurable intelligent surface arranged between the base station and the geographical region to be served, and a plurality of intermediate reconfigurable intelligent surfaces arranged between the base station and the main reconfigurable intelligent surface.

### CROSS-REFERENCE TO RELATED APPLICATIONS

This application is filed under 35 U.S.C. § 371 as the U.S. National Phase of Application No. PCT/EP2023/083712 entitled “Access network comprising reconfigurable reflective surfaces, method and device for controlling such an access network” and filed Nov. 30, 2023, and which claims priority to FR2212709 filed Dec. 2, 2022, each of which is incorporated by reference in its entirety.

### BACKGROUND

### Field

This development falls within the field of wireless communication systems, and relates more particularly to an access network for exchanging data with user terminals via reconfigurable reflective surfaces (known in particular as “reconfigurable intelligent surfaces”, RIS, in the literature and hereinafter), as well as to a control method for controlling such an access network.

### Description of the Related Technology

In this disclosure, a reconfigurable intelligent surface corresponds to a surface comprising a plurality of elements for which the respective reflective properties can be modified by a control module for said reconfigurable intelligent surface (for example, see [Renzo2020]), and is hereinafter referred to as “RIS” for brevity. Such an RIS is intended to reflect incident radio signals passively, i.e. with no amplification of said incident radio signals by amplifiers (neither low-noise amplifiers nor power amplifiers). By modifying the reflective properties of each element of the RIS via the control module, for example by individually modifying the phase shift introduced by each of these elements, it is therefore possible to influence the manner in which these incident radio signals are reflected by the RIS, and, ultimately, to influence the propagation channel followed by these radio signals. The energy consumption of an RIS is negligible compared to that of a base station, and an RIS is also simpler to install from a technical and regulatory point of view.

FIG. 1 schematically represents an example of a wireless communication system using an RIS 12. As illustrated in FIG. 1, the wireless communication system comprises a base station 11 installed on top of a building, which needs to exchange data (on a downlink and/or an uplink) with user terminals located in a geographical region ZG to be served. In this example, the direct paths between the base station 11 and the geographical region ZG to be served are obstructed by buildings, such that the radio signals using these direct paths are greatly attenuated or even completely blocked.

By placing an RIS 12 on an adjacent building, it is possible to improve the reflection of incident radio signals by this adjacent building, and thus to encourage an indirect path between the geographical region ZG and the base station 11, via the RIS 12. For example, the phase shifts introduced by the various elements of the RIS 12 may be adjusted by the control module for said RIS 12, autonomously or, for example, under the control of the base station 11 via a backhaul network. The use of the RIS 12 therefore allows influencing the propagation channel between the user terminals and the base station 11, and to do so in a controlled manner that makes it possible to enable communications between the base station 11 and the user terminals located in the geographical region ZG, based on the estimated propagation channels between the base station 11 and the user terminals.

RISs are therefore considered to be a promising technique for wireless communication systems, for example 5G-Advanced or 6G.

RISs are considered in particular within a context of spatial multiplexing of different user terminals (“multi-user multiple input multiple output”, MU-MIMO, in the literature) in which several user terminals use the same temporal communication resources (at the same time) and frequency communication resources (on the same frequency channel), but can nevertheless be discriminated between at reception when the respective propagation channels of the different user terminals are sufficiently decorrelated from each other. In such a context, the base station 11 typically comprises a network comprising a plurality of antennas, and the maximum number of user terminals that can be spatially multiplexed, when the propagation channels are sufficiently decorrelated from each other, corresponds to the minimum between the number of antennas of the network of the base station 11 and the number of elements of the RIS 12.

In practice, the number of user terminals that can actually be spatially multiplexed depends on the rank of the propagation channel matrix between the different user terminals and the different antennas of the network of the base station 11. However, in the case of the wireless communication system of FIG. 1 in which an RIS 12 is used to extend the coverage of a service in cases of greatly degraded propagation, this rank cannot be higher than the rank of the propagation channel matrix between the different antennas of the network of the base station 11 and the different elements of the RIS 12. However, this propagation channel matrix between the base station 11 and the RIS 12 may have a fairly low rank, particularly in the case of frequencies greater than 30 Gigahertz (GHz) (for example millimeter waves), or even greater than 1 Terahertz (THz), and in the case where the RIS 12 is in a situation of direct visibility with the base station 11. Thus, in such a case, the propagation channel between the base station 11 and the RIS 12 acts as a bottleneck which can significantly limit the achievable performance in terms of spatial multiplexing gain.

### SUMMARY

This disclosure aims to overcome all or part of the limitations of the prior art solutions, in particular those set forth above, by proposing a solution which makes it possible to improve, by means of reconfigurable intelligent surfaces, the rank of the propagation channel matrix between a base station equipped with an antenna array and a geographical region to be served, while limiting the increase in complexity in configuring the different elements of the reconfigurable intelligent surfaces.

To this end, this disclosure relates to an access network comprising a base station for exchanging data with user terminals located in a geographical region to be served, the base station comprising an antenna array, said access network further comprising a plurality of reconfigurable intelligent surfaces adapted to reflect incident radio signals, each reconfigurable intelligent surface being a surface comprising a plurality of elements for which their respective reflective properties are controllable by a control module for said reconfigurable intelligent surface. More particularly, the plurality of reconfigurable intelligent surfaces comprises a main reconfigurable intelligent surface and a plurality of intermediate reconfigurable intelligent surfaces:
the main reconfigurable intelligent surface being arranged between the intermediate reconfigurable intelligent surfaces and the geographical region to be served,
the intermediate reconfigurable intelligent surfaces being arranged between the base station and the main reconfigurable intelligent surface.

“Main reconfigurable intelligent surface arranged between the intermediate reconfigurable intelligent surfaces and the geographical region to be served” is understood to mean that, in the downlink direction (respectively in the uplink direction), radio signals originating from each intermediate reconfigurable intelligent surface (respectively originating from the geographical region) reach the geographical region (respectively each intermediate reconfigurable intelligent surface) via said main reconfigurable intelligent surface, after reflection by the latter. Similarly, “intermediate reconfigurable intelligent surface arranged between the base station and the main reconfigurable intelligent surface” is understood to mean that, in the downlink direction (respectively in the uplink direction), radio signals originating from the base station (respectively from the main reconfigurable intelligent surface) reach the main reconfigurable intelligent surface (respectively the base station) via said intermediate reconfigurable intelligent surface, after reflection by the latter.

Thus, at least some of the radio signals originating from the geographical region may reach the base station by being reflected first by the main reconfigurable intelligent surface, then by each intermediate reconfigurable intelligent surface, and vice versa, depending on the direction (uplink or downlink) considered.

The introduction of intermediate reconfigurable intelligent surfaces makes it possible to increase the rank of the propagation channel matrix between the base station and the main reconfigurable intelligent surface, by increasing the number of usable indirect paths between said base station and said main reconfigurable intelligent surface, each intermediate reconfigurable intelligent surface making it possible to introduce a separate indirect path between said base station and said main reconfigurable intelligent surface.

Furthermore, as indicated above, the reflective properties of the elements of the different reconfigurable intelligent surfaces (main and intermediate) may be controlled to improve the communication performance between the base station and the user terminals located in the geographical region to be served. These reflective properties are typically controlled according to the different propagation channels used, which must be estimated. The complexity of configuring the elements of the reconfigurable intelligent surfaces depends in particular on the complexity of estimating the different propagation channels used, and on the accuracy of the estimated propagation channels. In the proposed access network, the so-called “intermediate” propagation channels between the base station and each intermediate reconfigurable intelligent surface and between each intermediate reconfigurable intelligent surface and the main reconfigurable intelligent surface are essentially static or slowly varying. These intermediate propagation channels can therefore be estimated accurately and do not have to be estimated frequently, which limits the impact on the complexity of controlling the elements of the reconfigurable intelligent surfaces. Only the propagation channels, the so-called “main” channels, between the main reconfigurable intelligent surface and each user terminal must be estimated regularly, in particular because the user terminals may be mobile. However, the complexity of estimating these main propagation channels is similar to that of the prior art illustrated by FIG. 1, since the proposed access network is able to use a single main reconfigurable intelligent surface.

Thus, the proposed solution allows improving the rank of the propagation channel matrix between the base station and the user terminals located in the geographical region to be served, while limiting the increase in complexity in estimating the propagation channels, and therefore limiting the increase in complexity in controlling the elements of the reconfigurable intelligent surfaces.

In some particular embodiments, the access network may optionally further comprise one or more of the following features, individually or in any technically possible combination.

In some particular embodiments, some intermediate reconfigurable intelligent surfaces are arranged in different respective directions relative to the base station.

Such arrangements allow improving the increase in the rank of the propagation channel matrix between the antennas of the base station network and the elements of the main reconfigurable intelligent surface, by introducing intermediate reconfigurable intelligent surfaces.

In some particular embodiments, some intermediate reconfigurable intelligent surfaces are arranged in different respective directions relative to the main reconfigurable intelligent surface.

Such arrangements allow improving the increase in the rank of the propagation channel matrix between the antennas of the base station network and the elements of the main reconfigurable intelligent surface, by introducing intermediate reconfigurable intelligent surfaces.

In some particular embodiments, some intermediate reconfigurable intelligent surfaces are arranged in different respective directions relative to the main reconfigurable intelligent surface and are arranged in different respective directions relative to the base station.

Such an embodiment allows improving the rank of the propagation channel matrix between the antennas of the base station network and the elements of the main reconfigurable intelligent surface.

In some particular embodiments, the control module for a reconfigurable intelligent surface is configured to control a phase shift introduced during the reflection of incident radio signals by each element of said reconfigurable intelligent surface.

In some particular embodiments, the access network comprises at least two main reconfigurable intelligent surfaces arranged between the geographical region to be served and the intermediate reconfigurable intelligent surfaces, the number of main reconfigurable intelligent surfaces being less than the number of intermediate reconfigurable intelligent surfaces.

Such arrangements also allow improving the rank of the propagation channel matrix between the base station and the user terminals, while limiting the increase in complexity related to estimating the main propagation channels, since the number of main reconfigurable intelligent surfaces is less than the number of intermediate reconfigurable intelligent surfaces.

In some particular embodiments:
the base station is in a situation of direct visibility with all or part of the intermediate reconfigurable intelligent surfaces, and/or the main reconfigurable intelligent surface is in a situation of direct visibility with all or part of the geographical region to be served, and/or the main reconfigurable intelligent surface is in a situation of direct visibility with all or part of the intermediate reconfigurable intelligent surfaces.

In some particular embodiments, each intermediate reconfigurable intelligent surface may be activated/deactivated by the control module for said intermediate reconfigurable intelligent surface.

Such arrangements make it possible to modify dynamically the number of intermediate reconfigurable intelligent surfaces used, for example in order to limit it to what is strictly necessary for obtaining a rank of the propagation channel matrix which is sufficient for spatially multiplexing the user terminals with which data need to be exchanged.

According to a second aspect, there is provided a wireless communication system comprising an access network according to any of the embodiments of this disclosure and user terminals located in the geographical region to be served.

According to a third aspect, a control method is proposed for controlling an access network according to any of the embodiments of this disclosure, in order to exchange data with user terminals located in the geographical region to be served, said control method comprising:
an estimation of so-called intermediate propagation channels between the antennas of the base station network and the elements of the intermediate reconfigurable intelligent surfaces, and between the elements of the intermediate reconfigurable intelligent surfaces and the elements of the main reconfigurable intelligent surface,
a determination of a number K of user terminals that need to exchange data with the base station of the access network, from the geographical region to be served,
a selection, based on the estimated intermediate propagation channels, of a set of intermediate reconfigurable intelligent surfaces among all the intermediate reconfigurable intelligent surfaces, which make it possible to have a propagation channel matrix, between the antennas of the base station network and the elements of the main reconfigurable intelligent surface, that has a rank greater than or equal to K,
an activation of the intermediate reconfigurable intelligent surfaces of the selected set, and, when the selected set does not include all the intermediate reconfigurable intelligent surfaces, a deactivation of the intermediate reconfigurable intelligent surfaces that are not part of the selected set.

Such arrangements allow adapting the number of intermediate reconfigurable intelligent surfaces to the rank required for the propagation channel matrix, between the base station and the main reconfigurable intelligent surface, in order to be able to serve the user terminals with which data need to be exchanged.

In some particular embodiments, the control method may also optionally include one or more of the following features, individually or in all technically possible combinations.

In some particular embodiments, the control method further comprises an estimation of the so-called main propagation channels between the elements of the main reconfigurable intelligent surface and the K user terminals, and:
the selection of the set of intermediate reconfigurable intelligent surfaces is carried out based on the estimated main propagation channels, and further comprises the selection of values for the reflective properties of the elements of the intermediate reconfigurable intelligent surfaces of the set, the selection being made by searching for a set of intermediate reconfigurable intelligent surfaces and for values for the reflective properties of their elements which allow optimizing a determined communication performance criterion,
the activation of the intermediate reconfigurable intelligent surfaces of the selected set further comprises a configuration of the reflective properties of their elements, using the selected values.

In some particular embodiments, the determined communication performance criterion is representative of at least one among:
a data rate for data that can be exchanged between the base station and the user terminals,
a quality of service level for the data exchanges between the base station and the user terminals,
an energy efficiency for the data exchanges between the base station and the user terminals, etc.

According to a fourth aspect, a computer program product is provided comprising a set of program code instructions which, when executed by at least one processor, configure said at least one processor to implement a control method according to any of the embodiments of this disclosure.

According to a fifth aspect, a computer-readable storage medium is provided on which is stored a set of program code instructions which, when executed by at least one processor, configure said at least one processor to implement a control method according to any of the embodiments of this disclosure.

According to a sixth aspect, the development also relates to a control device for controlling an access network comprising a base station and a plurality of reconfigurable intelligent surfaces each comprising a plurality of elements for which their respective reflective properties are controllable by a control module, said plurality of reconfigurable intelligent surfaces comprising a main reconfigurable intelligent surface and a plurality of intermediate reconfigurable intelligent surfaces, the main reconfigurable intelligent surface being arranged between the intermediate reconfigurable intelligent surfaces and a geographical area to be served, and the intermediate reconfigurable intelligent surfaces being arranged between the base station and the main reconfigurable intelligent surface, this control device being configured to implement:
a selection, based on the estimated intermediate propagation channels between antennas of the antenna array of the base station and elements of intermediate reconfigurable intelligent surfaces, and between the elements of the intermediate reconfigurable intelligent surfaces and elements of the main reconfigurable intelligent surface, of a set of intermediate reconfigurable intelligent surfaces among all the intermediate reconfigurable intelligent surfaces which allow having a propagation channel matrix, between the antennas of the antenna array of the base station and the elements of the main reconfigurable intelligent surface, of a rank greater than or equal to a number K of user terminals that need to exchange data with the base station from the geographical area to be served, and
an activation of the intermediate reconfigurable intelligent surfaces of the selected set, and, when the selected set does not include all the intermediate reconfigurable intelligent surfaces, a deactivation of the intermediate reconfigurable intelligent surfaces that are not part of the selected set.

### BRIEF DESCRIPTION OF THE DRAWINGS

The development will be better understood upon reading the following description, given by way of non-limiting example, and made with reference to the figures which represent:

FIG. 1: a schematic representation of an access network according to the prior art, using a reconfigurable intelligent surface,

FIG. 2: a schematic representation of one exemplary embodiment of an access network according to this disclosure, using a plurality of reconfigurable intelligent surfaces, both main and secondary,

FIG. 3: a diagram illustrating the main steps of one exemplary implementation of a control method for controlling an access network;

FIG. 4: a diagram illustrating the main steps of another exemplary implementation of a control method for controlling an access network.

In these figures, identical references in different figures designate identical or similar elements. For clarity, the elements shown are not to scale unless otherwise indicated.

Furthermore, the order of steps shown in these figures is given solely as a non-limiting example of this disclosure, which may be applied with the same steps performed in a different order.

### DETAILED DESCRIPTION OF CERTAIN ILLUSTRATIVE EMBODIMENTS

FIG. 2 schematically represents one exemplary embodiment of an access network 20 of a wireless communication system. As illustrated in FIG. 2, the access network 20 comprises a base station 21 and a plurality of reconfigurable intelligent surfaces 22, 23 (hereinafter referred to as “RIS” for brevity). In the remainder of the description, we consider in a non-limiting manner the case where the rank of the propagation channel matrix must be improved for data exchanges between a base station 21 comprising a plurality of antennas and a determined geographical region ZG to be served. Obviously, the access network 20 may comprise a plurality of base stations 21, and the principles described below can be extended to the case where several base stations 21 serve said determined geographical region ZG.

The base station 21 comprises an antenna array (not shown in the figures) comprising M>1 antennas. The antenna array is for example a uniform linear array (ULA in the literature) in which the M antennas are arranged with a constant spacing along one dimension, or a uniform rectangular planar array (URPA in the literature) in which the M antennas are coplanar and are arranged along two dimensions with respective constant spacings, etc.

As illustrated in FIG. 2, the RISs 22, 23 are spatially distributed between the base station 21 and the geographical region ZG to be served, in order to improve performance in the communications between the base station 21 and the user terminals located in the geographical region ZG to be served. More particularly, at least one of the RISs, referred to as the “main RIS” 22, is located closer to the geographical region ZG to be served than the other RISs, referred to as the “intermediate RISs” 23. The intermediate RISs 23 are therefore arranged between the main RIS 22 and the base station 21. Thus, in the uplink direction, radio signals originating from the geographical region ZG reach the main RIS 22 without passing through other RISs, and reach each intermediate RIS 23 by being reflected by said main RIS 22. In the downlink direction, radio signals reflected by each intermediate RIS 23 therefore reach the geographical region ZG to be served after reflection by the main RIS 22. Each intermediate RIS 23 therefore allows establishing a separate indirect path between the base station 21 and the geographical region ZG. A main RIS 22 is considered “main” in that it is located on a plurality of separate indirect paths established by different intermediate RISs 23. In the example of FIG. 2, where the access network 20 comprises only one main RIS 22, all these separate indirect paths established by the intermediate RISs 23 pass through said main RIS 22.

The RISs 22, 23 comprise a control module (not shown in the figures) and elements (not shown in the figures) whose reflective properties can be modified by the control module.

The control module comprises, for example, at least one processor and at least one memory (magnetic hard disk, electronic memory, optical disk, or any type of computer-readable storage medium) in which a computer program product is stored, in the form of a set of program code instructions to be executed in order to control the reflective properties of the elements of the RIS 22, 23. Additionally or alternatively, the control module may comprise one or more programmable logic circuits (FPGA, PLD, etc.), and/or one or more specialized integrated circuits (ASIC, etc.), and/or a set of discrete electronic components, etc., adapted to carry out all or part of controlling the elements of the RIS 22, 23.

In preferred embodiments of the access network 20, the control module is also adapted to activate/deactivate each intermediate RIS 23. Such activation/deactivation may, for example, be carried out by modifying the reflective properties of the elements of the intermediate RIS 23 so that the incident radio signals are completely absorbed by said elements (for example, see [Molero2021]).

The elements of the RISs 22, 23 for which the reflective properties can be controlled by the control module, may be of any type known to the person skilled in the art (for example, see [Renzo2020]). Different RISs of the access network 20 may use different types of elements or the same type of elements. Controlling the “reflective properties” is generally understood to mean controlling the manner in which radio signals incident on an element are reflected by it. For example, it is possible to control a phase shift introduced by said element, or to control a level of absorption by said element (to modify the amplitude of the reflected radio signals), etc. The reflection of the incident radio signals by the elements is done passively, meaning with no amplification of said incident radio signals by amplifiers (neither low-noise amplifiers nor power amplifiers). However, the power consumption of an RIS 22, 23 is not zero, but it is limited to the power consumption required by the control module for configuring the elements of the RIS 22, 23. The power consumption of an RIS 22, 23 is much lower than that of a base station 21.

In the remainder of the description, it is considered, in a non-limiting manner, that the modified reflective properties correspond to the phase shift introduced by each element, for all the RISs 22, 23 of the access network 20.

The access network 20 comprises I≥2 intermediate RISs 23. The number I of intermediate RISs 23 is, for example, less than or equal to the number M of antennas in the antenna array of the base station 21. However, nothing precludes having more intermediate RISs 23 in other examples.

In the example illustrated in FIG. 2, the access network 20 advantageously comprises a single main RIS 22. In some cases, the access network 20 may comprise two or more main RISs 22. In such a case, each separate indirect path established by an intermediate RIS 23 (between the base station 21 and the geographical region ZG) passes through one of the main RISs 22, and each main RIS 22 is located on a plurality of indirect paths established by intermediate RISs 23. Where appropriate, the number of main RISs 22 is less than the number/of intermediate RISs 23, in order to limit the number of propagation channels to be estimated between the main RISs 22 and the user terminals located in the geographical region ZG to be served. The case where the access network 20 comprises a single main RIS 22 corresponds to the preferred embodiment of this disclosure. In the remainder of this description, the access network 20 is considered to comprise a single main RIS 22, but this is in no way limiting.

It should be noted that the number of elements per RIS 22, 23 may vary from one RIS to another. However, nothing precludes having the same number of elements for all the RISs 22, 23 in certain examples. In the remainder of the description, N denotes the number of elements of the main RIS 22, and Nᵢ denotes the number of elements of the intermediate RIS 23 of rank i, 1≤i≤1.

As indicated above, in itself, the introduction of intermediate RISs 23 between the base station 21 and the main RIS 22 allows increasing the rank of the propagation channel matrix between said base station 21 and said main RIS 22, by increasing the number of usable (indirect) paths. In general, however, the rank increase introduced by these intermediate RISs 23 may be more or less significant, and may depend on the positioning of the intermediate RISs relative to the base station 21 and relative to the main RIS 22 but also on the environment in which these intermediate RISs 23 are installed. The introduced increase in rank can therefore be maximized by a suitable choice of the respective positions of said intermediate RISs 23 within the access network 20.

Considering that data needs to be exchanged with K user terminals equipped with a single antenna, then the propagation channel matrix H between the base station 21 and the user terminals can be expressed in the following form:

$$G Φ {H}_{R}$$

an expression in which:
H_{R}=[h_{R,1} . . . h_{R,K}] corresponds to the matrix containing the so-called main propagation channels, between the N elements of the main RIS 22 and the K user terminals, h_{R,k} being the main propagation channel between the N elements of the main RIS 22 and the user terminal of rank k, 1≤k≤K,
Φ corresponds to the matrix (diagonal of dimensions N×N) containing the phase shifts introduced by the N elements of the main RIS 22,
G corresponds to the propagation channel matrix between the M antennas of the base station network 21 and the N elements of the main RIS 22.

The matrix G may be expressed in the following form:

$$G = {\sum }_{i = 1}^{I} {G}_{i} = {\sum }_{i = 1}^{I} {G}_{Bi} {Φ}_{i} {G}_{Ri}$$

an expression in which:
G_{Bi} corresponds to the matrix containing the so-called intermediate propagation channels between the M antennas of the network of the base station 21 and the Nᵢ elements of the intermediate RIS 23 of rank i, 1≤i≤I,
G_{Ri} corresponds to the matrix containing the intermediate propagation channels between the Nᵢ elements of the intermediate RIS 23 of rank i, 1≤i≤I, and the N elements of the main RIS 22,
Φᵢ corresponds to the matrix (diagonal of dimensions Nᵢ×Nᵢ) containing the phase shifts introduced by the Nᵢ elements of the intermediate RIS 23 of rank i, 1≤i≤I.

The addition of the intermediate RISs 23 therefore aims to increase the rank of the propagation channel matrix G between the M antennas of the base station network 21 and the N elements of the main RIS 22. In order to be able to spatially multiplex K user terminals, the rank of matrix G must be greater than or equal to K. If the goal is to be able to spatially multiplex a determined maximum number Kₘₐₓ, then the number I of intermediate RISs 23 and their respective positions must be chosen such that the rank of the matrix G is greater than or equal to Kₘₐₓ. However, the intermediate RISs 23 may also be introduced in order to improve the spatial multiplexing capacity of the access network 20 for the geographical region ZG to be served, without a specific goal concerning the number of user terminals to be spatially multiplexed.

In practice, it is possible to show that:

$$rank ( G ) = rank ( {\sum }_{i = 1}^{I} {G}_{Bi} {Φ}_{i} {G}_{Ri} ) \leq {\sum }_{i = 1}^{I} rank ( {G}_{Bi} {Φ}_{i} {G}_{Ri} )$$

As a result, the maximum rank of matrix G corresponds to

$${\sum }_{i = 1}^{I} rank ( {G}_{Bi} {Φ}_{i} {G}_{Ri} ) ,$$

and this maximum rank is reached if the following condition is satisfied:

$${G}_{i}^{H} {G}_{j} = 0 ∀ i \neq j ∈ \{ 1 , … , I \}$$

As a result, if the goal is to maximize the rank increase introduced by the I intermediate RISs 23, then these should be positioned such that:

$${G}_{i}^{H} {G}_{j} \approx 0 ∀ i \neq j ∈ \{ 1 , … , I \}$$

For example, it is possible to determine optimal positions of the various intermediate RISs 23 by simulation, for example using a 3D model of the environment in which said intermediate RISs 23 must be installed, and by looking for the positions which allow minimizing the products

$${G}_{i}^{H} {G}_{j} .$$

It is also possible to perform rank tests by physically installing the various intermediate RISs 23 in possible positions in the environment and to retain the/positions for which the best rank could be obtained among all the possible positions tested, for matrix G.

In practice, the rank of matrix G will be improved if the intermediate RISs 23 are spatially distributed relative to the base station 21 and/or relative to the main RIS 22, meaning that said intermediate RISs 23 are arranged in different respective directions relative to:
the base station 21, meaning that the angle measured at the base station 21 between the directions of two intermediate RISs 23 is non-zero (for example greater than 5° or greater than) 10° for each pair of intermediate RISs 23; and/or
the main RIS 22, meaning that the angle measured at the main RIS 22 between the directions of two intermediate RISs 23 is non-zero (for example greater than 5° or greater than) 10° for each pair of intermediate RISs 23.

It should be noted that the direction of an intermediate RIS 23 relative to the base station 21 (respectively relative to the main RIS 22) corresponds to the direction in which radio signals reflected by the intermediate RIS 23 arrive at the base station 21 (respectively at the main RIS 22). Consequently, this is the direction of the vector connecting the base station 21 (or the main RIS 22) to the intermediate RIS 23 in a line of sight (LOS) situation, or it is the direction of arrival of the main indirect path (i.e. with the most energy) if there is no direct path between the base station 21 (or the main RIS 22) and the intermediate RIS 23.

Preferably, in particular in the case where data exchanges with user terminals use high frequencies (for example, greater than 30 GHz or even greater than 1 THz):
the base station 21 is in a line of sight (LOS) situation with all or part of the intermediate RISs 23, and/or
the main RIS 22 is in a line of sight (LOS) situation with all or part of the geographical region ZG to be served, and/or
the main RIS 22 is in a line-of-sight (LOS) situation with all or part of the intermediate RISs 23.

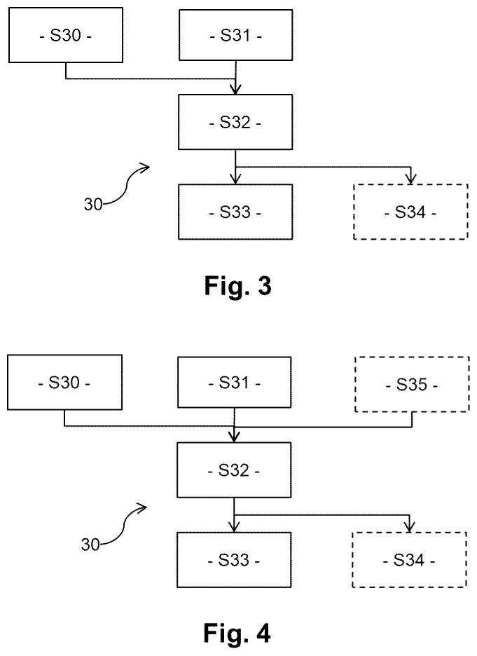

FIG. 3 schematically represents the main steps of a control method 30 for controlling an access network 20 as described above, when the control module is adapted to activate/deactivate the intermediate RISs 23.

As illustrated by FIG. 3, the control method 30 in particular comprises a step S30 of estimating the intermediate propagation channels between the M antennas of the network of the base station 21 and the elements of the intermediate RISs (i.e. estimating the matrices G_{Bi}, 1≤i≤I), and the intermediate propagation channels between the elements of the intermediate RISs 23 and the elements of the main RIS 22 (i.e. estimating the matrices G_{Ri}, 1≤i≤I). Step S30 therefore provides estimated matrices Ĝ_{Bi} and Ĝ_{Ri}, 1≤i≤I. The estimation of these matrices may make use of any method known to the person skilled in the art (for example, see [Zhou2022]). As indicated above, the matrices G_{Bi} and G_{Ri} (1≤i≤I) are essentially static or slowly varying, so they do not have to be estimated frequently and in some cases may be estimated only once.

In the example illustrated by FIG. 3, the control method 30 also comprises a step S31 of determining the number K of user terminals that need to exchange data with the base station 21 from the geographical region ZG to be served. The number K may be determined using any method known to those skilled in the art. The number K here corresponds to the number of user terminals to be served at a given time, and therefore changes over time. Because the aim is to adapt the number of active intermediate RISs 23 dynamically to the number of user terminals to be served, the number K must therefore be determined each time an adaptation to the number of active intermediate RISs 23 is considered.

In the example illustrated by FIG. 3, the control method 30 also comprises a step S32 of selecting, based on the estimated intermediate propagation channels (Ĝ_{Bi} and Ĝ_{Ri}, 1≤i≤I), a set of intermediate RISs 23 among all I intermediate RISs 23, which makes it possible to have a propagation channel matrix, between the M antennas of the network of the base station 21 and the N elements of the main RIS 22, having a rank that is greater than or equal to the number K determined during step S31. This selection step S32 aims for example to determine a set {xᵢ, 1≤i≤1}, with xᵢ=0 if the intermediate RIS 23 of rank i is deactivated and xᵢ=1 if it is activated, such that the following expression is satisfied:

$$rank ( {\sum }_{i = 1}^{I} {x}_{i} \times ( {\hat{G}}_{Bi} {Φ}_{i} {\hat{G}}_{Ri} ) ) \geq K$$

It should be noted that, in the previous expression, the Φᵢ matrices are diagonal with all non-zero diagonal coefficients (phase shifts), so they do not modify the rank of the matrix

$${\sum }_{i = 1}^{I} {x}_{i} \times ( {\hat{G}}_{Bi} {Φ}_{i} {\hat{G}}_{Ri} ) .$$

Therefore, in the example illustrated in FIG. 3, the selection of the set of intermediate RISs can be performed without seeking to optimize the Φᵢ matrices, and may be performed by considering for example that each Φᵢ matrix is equal to the identity matrix of dimensions Nᵢ×Nᵢ.

Considering the previous expression, the selected set of intermediate RISs 23 is for example composed of the intermediate RISs 23 for which xᵢ=1 in the determined set {xᵢ, 1≤i≤I}.

As illustrated in FIG. 3, the control method 30 then comprises a step S33 of activating the intermediate RISs 23 of the selected set, and, when the selected set does not include all the I intermediate RISs, a step S34 of deactivating the intermediate RISs 23 not forming part of the set selected during step S32.

Thus, the control method 30 of FIG. 3 allows adapting the number of activated intermediate RISs 23 to the necessary rank for the propagation channel matrix between the base station 21 and the main RIS 22, in order to be able to serve the K user terminals with which data needs to be exchanged. Such arrangements therefore allow reducing the power consumption of the intermediate RISs 23, but above all allow reducing the power consumption and the complexity of the processing carried out in particular by the base station 21 in order to discriminate between the K user terminals (for example multi-user detection algorithms, beamforming, spatial pre-coding for shaping the radio signals transmitted to the K user terminals, etc.).

FIG. 4 schematically represents the main steps of a preferred embodiment of the control method 30. In addition to the steps illustrated by FIG. 3, in this example the control method 30 comprises a step S35 of estimating main propagation channels between the N elements of the main RIS 22 and the K user terminals (i.e. estimating the matrix H_{R}). As indicated above, where applicable the matrix H_{R} must be estimated regularly, in particular because the K user terminals may be mobile.

The estimated matrix Ĥ_{R} may then be used, during the selection step S32, to further determine values for the reflective properties for the intermediate RISs 23 of the selected set and for the main RIS 22 (i.e. selecting matrices Φᵢ and Φ), making it possible to optimize a determined communication performance criterion. The communication performance criterion is presented for example in the form of a cost function ƒ to be optimized, for example to be maximized, in which case the selection step S32 aims in this case to solve the following expression:

$$arg max f ( {x}_{1} , … , {x}_{I} , {Φ}_{1} , … , {Φ}_{I} , Φ )$$

with the constraint:

$$rank ( {\sum }_{i = 1}^{I} {x}_{i} \times ( {\hat{G}}_{Bi} {Φ}_{i} {\hat{G}}_{Ri} ) ) \geq K$$

expressions in which xᵢ ∈{0,1}, and the matrices Φᵢ and Φ are diagonal and the modulus of each diagonal coefficient of each of these matrices Φᵢ and Φ is generally between 0 and 1, and is strictly equal to 1 in the case where only a phase shift is introduced by the different elements of the RISs 22, 23.

Other constraints may optionally be taken into account when optimizing the communication performance criterion. For example, the optimization may be carried out under a signal-to-noise ratio constraint (for example by imposing a signal-to-noise ratio that is greater than or equal to a determined minimum value for all or part of the K user terminals), or under a transmission power constraint (for example by imposing a transmission power for the base station 21 that is less than or equal to a determined maximum value, and/or by imposing a transmission power for all or part of the K user terminals that is less than a determined maximum value), etc. Additionally or alternatively, the optimization may be carried out under a constraint of a guaranteed minimum throughput for each user terminal (the guaranteed minimum throughput may vary from one user terminal to another), or under the constraint of a guaranteed minimum quality of service level for each user terminal (the guaranteed minimum level may vary from one user terminal to another), etc. It should be noted that such constraints may also be taken into account independently of the communication performance criterion, in the case of the mode of implementation of FIG. 3.

In general, any type of communication performance criterion may be considered, and the choice of a particular type of communication performance criterion only corresponds to one possible variant of this disclosure. For example, the determined communication performance criterion is representative of at least one among:
a data rate for data that can be exchanged between the base station 21 and the user terminals, in which case the optimization of the determined communication performance criterion aims, for example, to maximize the total data rate for data that can be exchanged between said base station 21 and the user terminals,
a quality of service level for the data exchanges between the base station 21 and the user terminals, in which case the optimization of the determined communication performance criterion aims, for example, to maximize the overall quality of service level for the data exchanges between said base station 21 and the user terminals (for example, by minimizing the latency of the exchanges),
an energy efficiency for the data exchanges between the base station 21 and the user terminals, in which case the optimization of the determined communication performance criterion aims, for example, to minimize the energy required to carry out the data exchanges between said base station 21 and the user terminals (for example, by minimizing the transmission power), etc.

During step S33 of activating the intermediate RISs 23 of the selected set (designated by the values xᵢ that allowed optimizing the communication performance criterion), the reflective properties of the elements of said intermediate RISs 23 are controlled so as to introduce phase shifts corresponding to the matrices Φᵢ that made it possible to optimize the communication performance criterion. Similarly, the reflective properties of the elements of the main RIS 22 are controlled to introduce phase shifts corresponding to the matrix Φ that made it possible to optimize the communication performance criterion.

In general, the control method 30 may be implemented by a control device. The control device comprises, for example, at least one processor and at least one memory (magnetic hard disk, electronic memory, optical disk, or any type of computer-readable storage medium) in which a computer program product is stored, in the form of a set of program code instructions to be executed in order to implement the different steps of the control method 30. Additionally or alternatively, the control device may comprise one or more programmable logic circuits (FPGA, PLD, etc.), and/or one or more specialized integrated circuits (ASIC, etc.), and/or a set of discrete electronic components, etc., adapted to carry out all or part of the steps of the control method 30 for the access network. For example, the control device may be integrated into the base station 21. The different parameter values determined during the selection step S32 are then sent to the control modules of the RISs 22, 23 concerned, for example via a backhaul network.

Simulation results are given below, illustrating the rank increase introduced by the intermediate RISs 23 between the main RIS 22 and the base station 21 of the access network 20.

In this simulation, as an example it was considered that:
the antenna array of the base station 21 comprises M=100 antennas organized into an URPA comprising 10 rows and 10 columns,
the main RIS 22 comprises N=100 elements organized into a URPA comprising 10 rows and 10 columns,
the access network 20 comprises I=5 intermediate RISs 23 arranged between the base station 21 and the main RIS 22, each intermediate RIS 23 comprising Nᵢ=50 elements organized into an URPA comprising 5 rows and 10 columns ∀i∈{1, . . . , I},
K=10 user terminals are to be served in the geographical region ZG, said user terminals not being in a situation of direct visibility with either the base station 21 or the intermediate RISs (for example due to the presence of obstacles such as buildings), said user terminals being in a situation of direct visibility only with the main RIS 22.

In this simulation, the azimuth and elevation directions of the intermediate RISs 23 relative to the base station 21 are given respectively by the following vectors

$${φ}_{{r}_{B}}^{a} and {φ}_{{r}_{B}}^{e}$$

(expressed in degrees, the coefficient of rank i corresponding to the value for the intermediate RIS 23 of rank i):

$${φ}_{{r}_{B}}^{a} = [ - 60 , - 30 , 0 , 30 , 60 ] \\ {φ}_{{r}_{B}}^{e} = [ - 20 , - 20 , - 5 , - 5 , - 5 ]$$

The azimuth and elevation directions of the base station 21 relative to the intermediate RISs 23 are given respectively by the following vectors

$${φ}_{{t}_{B}}^{a} and {φ}_{{t}_{B}}^{e} :$$

$${φ}_{{t}_{B}}^{a} = [ - 60 , - 30 , 0 , 30 , 60 ] \\ {φ}_{{t}_{B}}^{e} = [ 20 , 20 , 5 , 5 , 5 ]$$

The azimuth and elevation directions of the main RIS 22 relative to the intermediate RISs 23 are given respectively by the following vectors

$${φ}_{{r}_{R}}^{a} and {φ}_{{r}_{R}}^{e} :$$

$${φ}_{{r}_{R}}^{a} = [ - 60 , - 20 , 0 , 30 , 58 ] \\ {φ}_{{r}_{R}}^{e} = [ 20 , 20 , 5 , 5 , 5 ]$$

The azimuth and elevation directions of the intermediate RISs 23 relative to the main RIS 22 are given respectively by the following vectors

$${φ}_{{t}_{R}}^{a} and {φ}_{{t}_{R}}^{e} :$$

$${φ}_{{t}_{B}}^{a} = [ - 60 , - 35 , 0 , 25 , 55 ] \\ {φ}_{{t}_{B}}^{e} = [ - 20 , - 20 , - 5 , - 5 , - 5 ]$$

Furthermore, the distance between each intermediate RIS 23 and the base station 21 is considered to be 500 m. The distance between each intermediate RIS 23 and the main RIS 22 is also considered to be 500 m. In this simulation, the matrices G_{Bi} and G_{Ri} (1≤i≤I) were modeled using a Rician channel model with a dominant LOS component for each of the intermediate propagation channels. An NLOS component (indirect path) was also taken into account using a correlated Rayleigh channel model. The spatial correlation was modeled using a one-ring scattering model.

With the above parameters, the simulation showed that the matrix

$$G = {\sum }_{i = 1}^{I} {G}_{Bi} {Φ}_{i} {G}_{Ri}$$

obtained with the intermediate RISs 23 had a rank equal to 49.

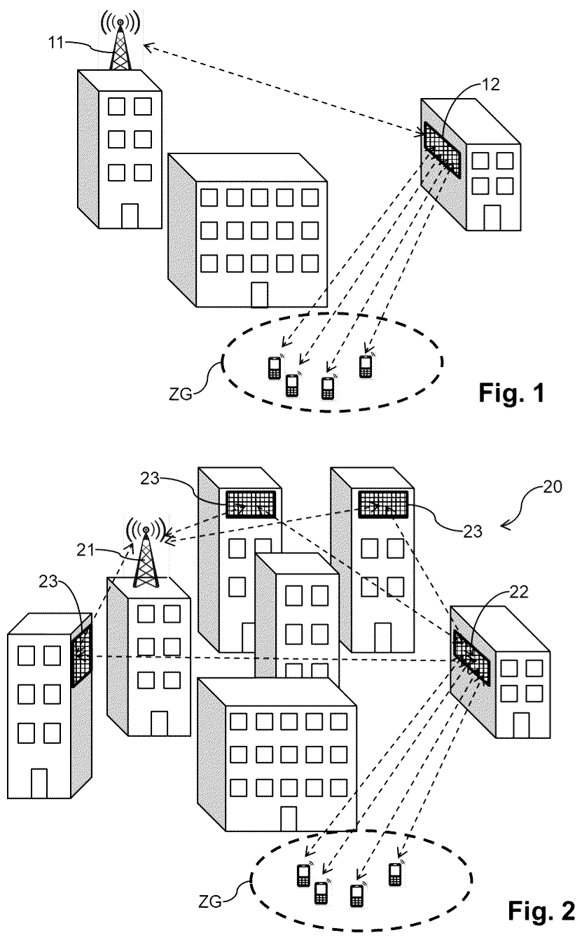

For comparison, a simulation was carried out which considered only the main RIS 22 (i.e. removing the intermediate RISs 23 to return to the case in FIG. 1), with a LOS (and NLOS) component between the main RIS 22 and the base station 21 and a distance of 1 km between said main RIS 22 and the base station 21. In this case, the performed simulation showed that the rank of the propagation channel matrix between the base station 21 and said main RIS 22 was equal to 16, demonstrating the advantages of intermediate RISs for increasing the rank of the propagation channel matrix.

More generally, it should be noted that the embodiments and modes of implementation considered above have been described as non-limiting examples, and that other variants are therefore conceivable.

### REFERENCES

[Renzo2020] M. D. Renzo, A. Zappone, M. Debbah, M. Alouini, C. Yuen, J. D. Rosny, and S. Tretyakov. “Smart Radio Environments Empowered by Reconfigurable Intelligent Surfaces: How it Works, State of Research, and Road Ahead”. IEEE Journal on Selected Areas in Communications, pages 1-1, 2020.
[Zhou2022] G. Zhou, C. Pan, H. Ren, P. Popovski and A. L. Swindlehurst, “Channel Estimation for RIS-Aided Multiuser Millimeter-Wave Systems,” in IEEE Transactions on Signal Processing, vol. 70, pp. 1478-1492, 2022, doi: 10.1109/TSP.2022.3158024.
[Molero2021] C. Molero et al., “Metamaterial-Based Reconfigurable Intelligent Surface: 3D Meta-Atoms Controlled by Graphene Structures,” in IEEE Communications Magazine, vol. 59, no. 6, pp. 42-48, June 2021, doi: 10.1109/MCOM.001.2001161.

1. An access network comprising:
a base station for exchanging data with a number K of user terminals located in a geographical region to be served, the base station comprising an antenna array; and
a plurality of reconfigurable intelligent surfaces adapted to reflect incident radio signals, each reconfigurable intelligent surface being a surface comprising a plurality of elements for which their respective reflective properties are controllable by a control module for the reconfigurable intelligent surface, the plurality of reconfigurable intelligent surfaces comprising a main reconfigurable intelligent surface and a plurality of intermediate reconfigurable intelligent surfaces, the main reconfigurable intelligent surface being arranged between the intermediate reconfigurable intelligent surfaces and the geographical region to be served, and the intermediate reconfigurable intelligent surfaces being arranged between the base station and the main reconfigurable intelligent surface;
wherein:
a set of intermediate reconfigurable intelligent surfaces is capable of being activated, among all the intermediate reconfigurable intelligent surfaces, based on the estimated intermediate propagation channels, in order to allow having a propagation channel matrix of a rank greater than or equal to K, between antennas of the network of the base station and elements of the main reconfigurable intelligent surface, the estimated intermediate propagation channels being between the antennas of the network of the base station and elements of the intermediate reconfigurable intelligent surfaces, and between the elements of the intermediate reconfigurable intelligent surfaces and the elements of the main reconfigurable intelligent surface, and
when the set does not include all the intermediate reconfigurable intelligent surfaces, the intermediate reconfigurable intelligent surfaces that are not part of the set are capable of being deactivated.

2. The access network according to claim 1, wherein some intermediate reconfigurable intelligent surfaces are arranged in different respective directions relative to the base station.

3. The access network according to claim 1, wherein some intermediate reconfigurable intelligent surfaces are arranged in different respective directions relative to the main reconfigurable intelligent surface.

4. The access network according to claim 1, wherein the control module for a reconfigurable intelligent surface is configured to control a phase shift introduced during the reflection of incident radio signals by each element of the reconfigurable intelligent surface.

5. The access network according to claim 1, comprising at least two main reconfigurable intelligent surfaces arranged between the geographical region to be served and the intermediate reconfigurable intelligent surfaces, the number of main reconfigurable intelligent surfaces being less than the number of intermediate reconfigurable intelligent surfaces.

6. The access network according to claim 1, wherein:
the base station is in a situation of direct visibility with all or part of the intermediate reconfigurable intelligent surfaces, and/or
the main reconfigurable intelligent surface is in a situation of direct visibility with all or part of the geographical region (ZG) to be served, and/or
the main reconfigurable intelligent surface is in a situation of direct visibility with all or part of the intermediate reconfigurable intelligent surfaces.

7. The access network according to claim 1, wherein each intermediate reconfigurable intelligent surface may be activated/deactivated by the control module for the intermediate reconfigurable intelligent surface.

8. A wireless communication system, comprising an access network according to claim 1 and user terminals located in the geographical region to be served.

9. A control method for controlling an access network according to claim 7 in order to exchange data with user terminals located in the geographical region to be served, the control method comprising:
estimating so-called intermediate propagation channels between the antennas of the network of the base station and the elements of the intermediate reconfigurable intelligent surfaces, and between the elements of the intermediate reconfigurable intelligent surfaces and the elements of the main reconfigurable intelligent surface,
determining a number K of user terminals that need to exchange data with the base station of the access network, from the geographical region to be served,
selecting, based on the estimated intermediate propagation channels, of a set of intermediate reconfigurable intelligent surfaces among all the intermediate reconfigurable intelligent surfaces, which make it possible to have a propagation channel matrix, between the antennas of the network of the base station and the elements of the main reconfigurable intelligent surface, that has a rank greater than or equal to K, and
activating the intermediate reconfigurable intelligent surfaces of the selected set, and, when the selected set does not include all the intermediate reconfigurable intelligent surfaces, deactivating the intermediate reconfigurable intelligent surfaces that are not part of the selected set.

10. The control method according to claim 9, further comprising estimating the so-called main propagation channels between the elements of the main reconfigurable intelligent surface and the K user terminals, and wherein:
selecting of the set of intermediate reconfigurable intelligent surfaces is carried out based on the estimated main propagation channels, and further comprises selecting values for the reflective properties of the elements of the intermediate reconfigurable intelligent surfaces of the set, the selection being made by searching for a set of intermediate reconfigurable intelligent surfaces and for values for the reflective properties of their elements which allow optimizing a determined communication performance criterion,
the activating of the intermediate reconfigurable intelligent surfaces of the selected set further comprises configuring the reflective properties of their elements, using the selected values.

11. The control method according to claim 10, wherein the determined communication performance criterion is representative of at least one among:
a data rate for data that can be exchanged between the base station and the user terminals,
a quality of service level for the data exchanges between the base station and the user terminals,
an energy efficiency for the data exchanges between the base station and the user terminals.

12. A control device for controlling an access network comprising a base station and a plurality of reconfigurable intelligent surfaces each comprising a plurality of elements for which their respective reflective properties are controllable by a control module, the plurality of reconfigurable intelligent surfaces comprising a main reconfigurable intelligent surface and a plurality of intermediate reconfigurable intelligent surfaces, the main reconfigurable intelligent surface being arranged between the intermediate reconfigurable intelligent surfaces and a geographical area to be served, and the intermediate reconfigurable intelligent surfaces being arranged between the base station and the main reconfigurable intelligent surface, the control device being configured to implement:
a selection, based on the estimated intermediate propagation channels between antennas of the antenna array of the base station and elements of intermediate reconfigurable intelligent surfaces, and between the elements of the reconfigurable intelligent surfaces intermediate and elements of the main reconfigurable intelligent surface, of a set of intermediate reconfigurable intelligent surfaces among all the intermediate reconfigurable intelligent surfaces which allow having a propagation channel matrix, between the antennas of the antenna array of the base station and the elements of the main reconfigurable intelligent surface, of a rank greater than or equal to a number K of user terminals that need to exchange data with the base station from the geographical area to be served, and
an activation of the intermediate reconfigurable intelligent surfaces of the selected set, and, when the selected set does not include all the intermediate reconfigurable intelligent surfaces, a deactivation of the intermediate reconfigurable intelligent surfaces that are not part of the selected set.

13. A processing circuit comprising at least one processor and a memory, the memory storing program code instructions of a computer program which, when executed by the at least one processor, configure the at least one processor to implement the control method according to claim 9.

14. A non-transitory computer-readable storage medium on which is stored a set of program code instructions which, when executed by at least one processor, configure the at least one processor to implement the control method according to claim 9.
